(19) United States
(12) Patent Application Publication
(10) Pub. No.: US 2015/0212335 A1
(43) Pub. Date: Jul. 30, 2015

(54) REFLECTIVE TYPE IMAGING ELEMENT AND OPTICAL SYSTEM, AND METHOD OF MANUFACTURING RELECTIVE TYPE IMAGING ELEMENT

(71) Applicant: Sharp Kabushiki Kaisha, Osaka-shi, Osaka (JP)

(72) Inventor: Takafumi Shimatani, Osaka-shi (JP)

(21) Appl. No.: 14/419,039

(22) PCT Filed: Aug. 2, 2013
(86) PCT No.: PCT/JP2013/070994

§ 371 Date: Feb. 2, 2015

(30) Foreign Application Priority Data
Aug. 3, 2012 (JP) 2012-173200

(51) Int. Cl. G02B 27/22; G02B 5/20; G02B 5/02; G02B 5/08

(52) U.S. Cl. CPC G02B 27/2292; G02B 5/0816; G02B 5/205; G02B 5/0284

(57) ABSTRACT

This reflective imaging element (1) includes: a first reflective element (11); and a second reflective element (21) arranged over the first reflective element. Each of the first and second reflective elements has a multilayer structure in which a plurality of unit reflective elements are stacked one upon the other. Each of the plurality of unit reflective elements includes a light transmitting portion (1111), a reflective layer (1113), and an optical attenuation layer (1115) arranged between the light transmitting portion and the reflective layer. The plurality of unit reflective elements include two unit reflective elements which are adjacent to each other and which are arranged so that the light transmitting portion of one of the two unit reflective elements is adjacent to the reflective layer of the other unit reflective element. And the direction in which the plurality of unit reflective elements are stacked in the first reflective element and the direction in which the plurality of unit reflective elements are stacked in the second reflective element intersect with each other at right angles.

### TECHNICAL FIELD

The present invention relates to a reflective imaging element which can form an image of an object in a space, an optical system including such a reflective imaging element, and a method for fabricating such a reflective imaging element.

### BACKGROUND ART

In recent years, an optical system for forming an image of an object in a space by using a reflective imaging element has been proposed (in Patent Documents 1 and 2, for example). The optical system includes a reflective imaging element and an object. And an image to be produced in a space by such an optical system is an image of the object which has been formed at a position that is symmetric with respect to the reflective imaging element as a plane of symmetry.

Such an optical system uses the specular reflection of a reflective imaging element. As the reflective imaging element, disclosed is an optical element which has a through hole that runs through a plate-like substrate in its thickness direction and which is comprised of two specular elements that cross at right angles with the inner wall of the hole (see FIG. 4 of Patent Document 1). Such an optical element will be hereinafter referred to as a “unit optical element”.

In the reflective imaging element disclosed in Patent Document No. 1, light coming from the object is sequentially reflected by those two specular elements and then goes out of this reflective imaging element, thereby forming an image of the object. In principle, the ratio in size between the image of the object and the image produced in the space should be one to one.

In such an optical system, when an object is arranged tilted with respect to the reflective imaging element, the image produced in the air (which will be hereinafter referred to as an “aerial image”) also gets angled. As a result, the aerial image would look to the viewer's eye as if that image was floating in the space.

In the optical system described above, an image which is displayed on a display panel (such as a liquid crystal display panel) may be used as the object. In that case, the image displayed on the display panel is projected upright in the air. As a result, even though the image displayed on the display panel is actually a two-dimensional image, it looks, to the viewer's eye, as if a three-dimensional image was being produced in the air. In this description, such an image that makes the viewer sense as if a three-dimensional image were floating in the air will be hereinafter sometimes referred to as an “airy image”.

The entire disclosures of Patent Documents Nos. 1 and 2 are hereby incorporated by reference.

### CITATION LIST

### Patent Literature

Patent Document No. 1: Japanese Laid-Open Patent Publication No. 2008-158114
Patent Document No. 2: PCT International Application Publication No. 2009/136578

### SUMMARY OF INVENTION

### Technical Problem

In the optical system described above, the light coming from the object includes light rays which are reflected once apiece from each of the two specular elements inside each unit optical element and which contribute to forming an image of the object at a position which is symmetric with respect to the reflective imaging element as a plane of symmetry. Nevertheless, the light going from the reflective imaging element toward the viewer also include other light rays that do not contribute to forming an image of the object at such a position that is symmetric with respect to the reflective imaging element as a plane of symmetry. In the following description, the latter light rays that do not contribute to forming an image of the object at such a position that is symmetric with respect to the reflective imaging element as a plane of symmetry will be hereinafter referred to as “stray light rays”.

Those stray light rays include light rays which have come from the object and which are reflected internally from a surface of the unit optical element with no specular elements (which will be hereinafter referred to as “first type of stray light rays”) and light rays which have not come from the object but from somewhere else (e.g., from an illuminating light source) and which are also reflected internally from a surface of the unit optical element with no specular elements (which will be hereinafter referred to as “second type of stray light rays”).

Examples of the first type of stray light rays include light rays which are sequentially reflected from each of the two specular elements, further reflected from the surface with no specular elements and then emitted out of the reflective imaging element and light rays which are reflected from any of the two specular elements, further reflected from the surface with no specular elements, and then emitted out of the reflective imaging element. Examples of the second type of stray light rays include light ray which are reflected from the surface with no specular elements and then emitted out of the reflective imaging element and light rays which are reflected from the surface with no specular elements, further reflected from at least one of the two specular elements, and then emitted out of the reflective imaging element. It should be noted that if there are two surfaces with no specular elements inside each unit optical element, the light rays are reflected from the surface(s) with no specular elements either once or twice.

Those stray light rays would decrease the visibility of the aerial image that should be produced in the air. For example, the first type of stray light rays would sometimes cause another object image to be formed between the reflective imaging element and the viewer, thus making the viewer sense an unwanted aerial image there. Meanwhile, the second type of stray light rays would decrease the contrast ratio of the aerial image that should be produced.

The present inventors perfected our invention in order to overcome those problems by providing a reflective imaging element which can produce an airy image with high display quality.

### Solution to Problem

A reflective imaging element according to an embodiment of the present invention includes: a first reflective element; and a second reflective element arranged over the first reflective element. Each of the first and second reflective elements has a multilayer structure in which a plurality of unit reflective elements are stacked one upon the other. Each of the plurality of unit reflective elements includes a light transmitting portion, a reflective layer, and an optical attenuation layer arranged between the light transmitting portion and the reflective layer. The plurality of unit reflective elements include two unit reflective elements which are adjacent to each other and which are arranged so that the light transmitting portion of one of the two unit reflective elements is adjacent to the reflective layer of the other unit reflective element. And the direction in which the plurality of unit reflective elements are stacked in the first reflective element and the direction in which the plurality of unit reflective elements are stacked in the second reflective element intersect with each other at right angles.

In one embodiment, the optical attenuation layer includes a low optical density layer and a high optical density layer which has a higher optical density than the low optical density layer, and the low optical density layer is arranged closer to the light transmitting portion than the high optical density layer is.

In one embodiment, the high optical density layer includes a black coloring agent.

In one embodiment, the low optical density layer includes at least one dielectric layer, and the high optical density layer includes a metal layer.

In one embodiment, the high optical density layer has a diffuse reflective surface which faces the light transmitting portion.

In one embodiment, the light transmitting portion has a diffuse reflective surface which faces the high optical density layer.

An optical system according to an embodiment of the present invention includes: a reflective imaging element according to any of the embodiments described above; and a display panel which is arranged on a light-incident side of the reflective imaging element. The optical system forms an image which is displayed on a display screen of the display panel at a position which is symmetric with respect to the reflective imaging element as a plane of symmetry.

A reflective imaging element fabricating method according to an embodiment of the present invention is a method for fabricating a reflective imaging element according to any of the embodiments described above. The method includes the steps of: (a) providing a stack in which a plurality of unit structures are stacked one upon the other, each of the plurality of unit structures including a light transmitting substrate, a reflective layer, and an optical attenuation layer arranged between the light transmitting substrate and the reflective layer; (b) cutting the stack in a direction in which the plurality of unit structures are stacked one upon the other in the stack, thereby forming first and second reflective elements, each having a multilayer structure in which a plurality of unit reflective elements are stacked one upon the other; and (c) arranging the second reflective element over the first reflective element so that a direction in which the plurality of unit reflective elements are stacked in the first reflective element intersects at right angles with a direction in which the plurality of unit reflective elements are stacked in the second reflective element.

In one embodiment, the step (a) includes the step of applying a resin composition including a black coloring agent onto the reflective layer.

In one embodiment, the step (a) includes the step of forming a metal layer on the reflective layer.

In one embodiment, the step (a) includes the step of applying a resin composition including a black coloring agent onto one of the light transmitting substrate's principal surfaces that faces the reflective layer.

In one embodiment, the step (a) includes the step of forming a metal layer on one of the light transmitting substrate's principal surfaces that faces the reflective layer.

### Advantageous Effects of Invention

Embodiments of the present invention provide a reflective imaging element which can produce an airy image with high display quality.

### BRIEF DESCRIPTION OF DRAWINGS

FIG. 1 (a) is a schematic perspective view illustrating a configuration for a reflective imaging element according to an embodiment of the present invention. (b) is a schematic perspective view illustrating separately first and second reflective elements. And (c) is a schematic cross-sectional view illustrating a configuration for a multilayer structure in which a plurality of unit reflective elements are stacked one upon the other.

FIG. 2 A schematic cross-sectional view illustrating a configuration for a unit reflective element, of which the optical attenuation layer has a multilayer structure consisting of two or more layers.

FIG. 3 A schematic cross-sectional view illustrating a configuration for a unit reflective element, of which the optical attenuation layer has a multilayer structure consisting of two or more layers.

FIG. 4 (a) is a schematic cross-sectional view illustrating an exemplary configuration for a unit reflective element including an optical attenuation layer consisting of a low optical density layer and a high optical density layer. (b) is a schematic cross-sectional view illustrating an exemplary configuration for a unit reflective element including an optical attenuation layer consisting of a low optical density layer and a high optical density layer.

FIG. 5 A graph showing the respective refractive indices nₛ and extinction coefficients kₛ of various kinds of absorbers (including various metals and semiconductors) with respect to light falling within the visible radiation range.

FIG. 6 A schematic cross-sectional view illustrating an exemplary configuration for a unit reflective element including an optical attenuation layer consisting of a low optical density layer and a high optical density layer.

FIG. 7 (a) illustrates an example of a unit reflective element, of which the optical attenuation layer is a stack of a low optical density layer and a high optical density layer and in which the interface between the low optical density layer and the high optical density layer is a surface with micro-geometry. (b) illustrates an example of a unit reflective element, of which the optical attenuation layer is a stack of a low optical density layer and a high optical density layer and in which the interface between the light transmitting portion and the low optical density layer is a surface with micro-geometry.

FIG. 8 A schematic perspective view illustrating a configuration for an optical system according to an embodiment of the present invention.

FIGS. 9 (a) and (b) are schematic representations illustrating a single unit image forming element extracted from a reflective imaging element.

FIG. 10 Illustrates, as a comparative example, an optical system including a reflective imaging element with no optical attenuation layers.

FIG. 11 (a) through (d) illustrate, as a comparative example, a unit image forming element in the reflective imaging element including no optical attenuation layers.

FIGS. 12 (a) and (b) illustrate, as a comparative example, a unit image forming element in the reflective imaging element including no optical attenuation layers.

FIG. 13 (a) to (d) are schematic representations illustrating a single unit image forming element extracted from a reflective imaging element according to an embodiment of the present invention.

FIGS. 14 (a) and (b) are schematic representations illustrating generally how to fabricate a reflective imaging element according to this embodiment.

FIGS. 15 (a) and (b) are schematic cross-sectional views illustrating a stacked substrate in which a transparent substrate, a reflective layer and an optical attenuation layer are stacked one upon the other.

FIGS. 16 (a) and (b) are schematic representations illustrating generally how to fabricate a reflective imaging element according to this embodiment.

FIGS. 17 (a) and (b) are schematic representations illustrating generally how to fabricate a reflective imaging element according to this embodiment.

### DESCRIPTION OF EMBODIMENTS

Embodiments of the present invention will now be described with r to the accompanying drawings. It should be noted, however, that the present invention is in no way limited to the illustrative embodiments to be described below.

(Reflective Imaging Element)

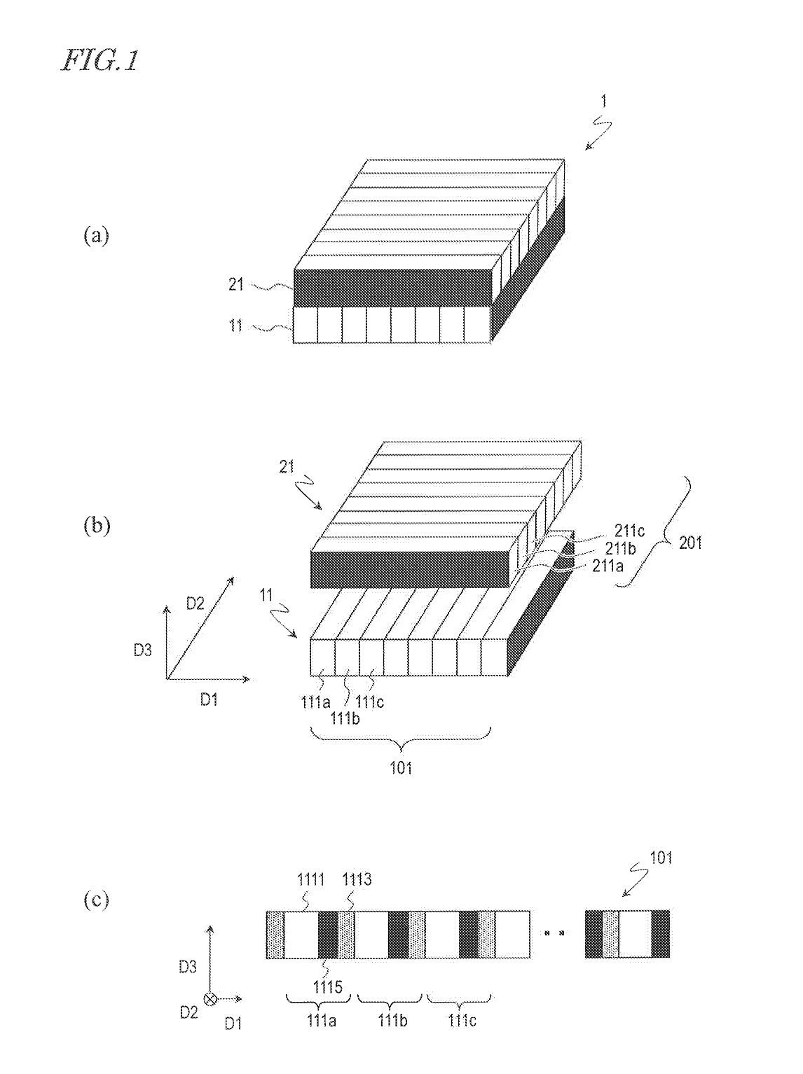

A reflective imaging element according to an embodiment of the present invention will be described with reference to FIGS. 1(a) to 1(c). Specifically, FIG. 1(a) is a schematic perspective view illustrating a configuration for a reflective imaging element 1 according to an embodiment of the present invention. FIG. 1(b) is a schematic perspective view illustrating separately first and second reflective elements 11 and 12 that the reflective imaging element 1 has. And FIG. 1(c) is a schematic cross-sectional view illustrating the configuration of the multilayer structure 101 that the first reflective element 11 has.

As shown in FIG. 1(a), the reflective imaging element 1 includes a first reflective element 11 and a second reflective element 12 arranged on the first reflective element 11. The second reflective element 21 is arranged in a direction D3 (which will be hereinafter referred to as a “third direction” and) which intersects at right angles with first and second directions D1 and D2 to be described later.

As shown in FIG. 1(b), the first reflective element 11 has a multilayer structure 101 in which a plurality of unit reflective elements 111a, 111b, 111c and so on are stacked one upon the other. Likewise, the second reflective element 21 also has a multilayer structure 201 in which a plurality of unit reflective elements 211a, 211b, 211c and so on are stacked one upon the other.

The direction D1 in which a plurality of unit reflective elements 111a, 111b, 111c and so on are stacked one upon the other in the first reflective element 11 (i.e., the first direction) and the direction D2 in which a plurality of unit reflective elements 211a, 211b, 211c and so on are stacked one upon the other in the second reflective element 21 (i.e., the second direction) intersect with each other at right angles. Alternatively, the plurality of unit reflective elements of the first reflective element 11 may also be stacked in the second direction D2, and the plurality of unit reflective elements of the second reflective element 21 may be arranged in the first direction D1.

FIG. 1(c) illustrates the first reflective element 11 as viewed parallel to the second direction D2. As shown in FIG. 1(c), the multilayer structure 101 has a structure in which the unit reflective elements 111a, 111b, 111c and so on are stacked one upon the other. As also shown in FIG. 11(c), each of the unit reflective elements includes a light transmitting portion 1111, a reflective layer 1113 and an optical attenuation layer 1115 which is arranged between the light transmitting portion 1111 and the reflective layer 1113. Since the second reflective element 21 has the same configuration as the first reflective element 11, description of the second reflective element 21 will be omitted herein.

As shown in FIG. 1(c), the plurality of unit reflective elements include two mutually adjacent unit reflective elements which are arranged so that the light transmitting portion 1111 of one unit reflective element is adjacent to the reflective layer 1113 of the other unit reflective element. In this description, if “two unit reflective elements are adjacent to each other”, it means that there are no other unit reflective elements intervening between those two unit reflective elements. For example, the unit reflective elements 111a and 111b are adjacent to each other as shown in FIG. 1(c). In this case, these unit reflective elements 111a and 111b are arranged so that the light transmitting portion 1111 of the unit reflective element 111b is adjacent to the reflective layer 1113 of the unit reflective element 111a.

Next, the light transmitting portion 1111, reflective layer 1113 and optical attenuation layer 1115 which are provided for each of the plurality of unit reflective elements will be described sequentially with one of the unit reflective elements shown in FIG. 1(c) taken as an example.

The light transmitting portion 1111 has a rectangular parallelepiped shape and is made of a light transmitting material. As shown in FIG. 1(b), the longitudinal direction of each of the plurality of unit reflective elements in the first reflective element 11 is parallel to the second direction D2 and the longitudinal direction of each of the plurality of unit reflective elements in the second reflective element 21 is parallel to the first direction D1.

The material for the light transmitting portion 1111 may be glass or transparent resin, for example. Examples of preferred transparent resins include acrylic resins such as polymethylmethacrylate (PMMA), polyethylene terephthalate (PET) and polycarbonate (PC).

The reflective layer 1113 is a light reflecting layer and may be made of a material such as aluminum (Al) or silver (Ag), for example.

The optical attenuation layer 1115 may include a layer including a black coloring agent, for example. Examples of preferred black coloring agents include a black pigment and a black dye, which may be used either separately from each other or in combination. As the black pigment, carbon black or titanium black may be used, for example. Optionally, the optical attenuation layer 1115 may be a black adhesive layer.

For example, by making the optical attenuation layer 115 function as a light absorber, emission of stray light rays out of the reflective imaging element 1 can be reduced significantly. It should be noted that the absorption property when light is transmitted through a substance with a certain thickness is represented by the optical density (OD). Supposing the intensity of incident light is I₀ and the intensity of the transmitted light is I, the optical density is represented by the following Equation (1):

OD=Log (I₀/I) (1)

If the optical attenuation layer 1115 is implemented as an adhesive layer including a black coloring agent, the adhesive layer including the black coloring agent suitably has an optical density of three or more.

As long as the emission of stray light rays out of the reflective imaging element 1 can be reduced significantly, the optical attenuation layer 1115 does not necessarily function as a light absorber. For example, the optical attenuation layer 1115 may have the function of attenuating the light reflected from the optical attenuation layer 1115 by taking advantage of the interference effect of light or the function of scattering the light incident on the optical attenuation layer 1115. A specific exemplary configuration for the optical attenuation layer 1115 will be described later.

The optical attenuation layer 1115 is arranged between the light transmitting portion 1111 and the reflective layer 1113. As shown in FIG. 1(c), the reflective layer 1113 is arranged parallel to a plane including the longitudinal direction of the light transmitting portion 1111 (i.e., the second direction D2). Therefore, the optical attenuation layer 1115 is also arranged parallel to a plane including the longitudinal direction of the light transmitting portion 1111. In other words, the plurality of optical attenuation layers 1115 in the first reflective element 11 intersect with the first direction D1 at right angles, and the plurality of optical attenuation layers 1115 in the second reflective element 12 intersect with the second direction D1 at right angles.

Part of the light transmitted through the light transmitting portion 1111 and incident on the optical attenuation layer 1115 is reflected from the surface of the optical attenuation layer 1115. That is why by decreasing the reflectance of the optical attenuation layer 1115, emission of stray light rays from the reflective imaging element 1 can be further reduced. For example, if the optical attenuation layer 1115 is a stack of multiple layers with mutually different optical densities, the reflectance of the optical attenuation layer 1115 can be reduced.

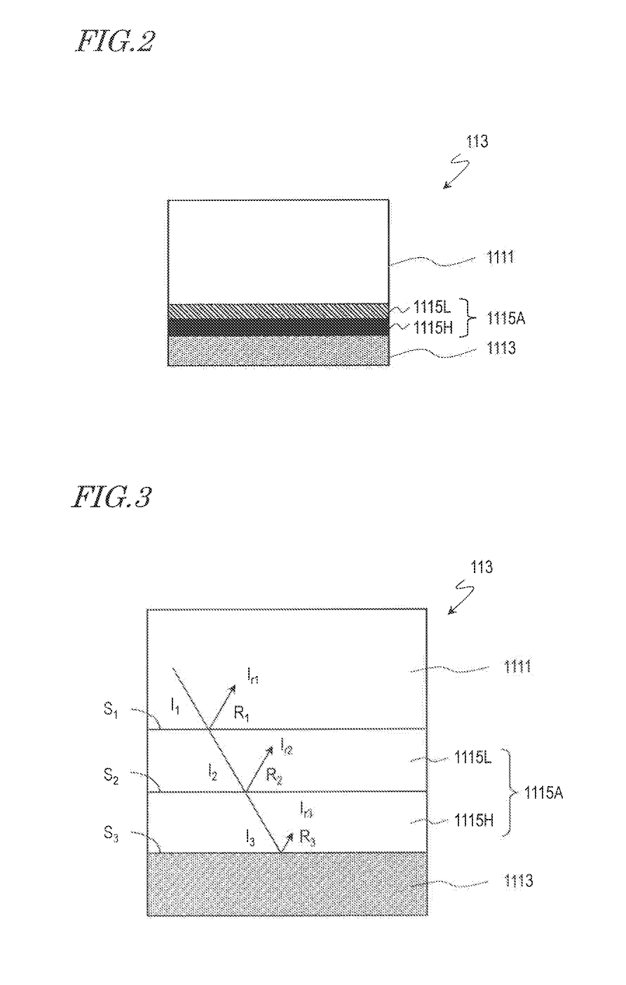

FIG. 2 is a schematic cross-sectional view illustrating a configuration for a unit reflective element 113, of which the optical attenuation layer has a multilayer structure consisting of two or more layers. The optical attenuation layer 1115A shown in FIG. 2 includes a low optical density layer 1115L and a high optical density layer 1115H with a higher optical density than the low optical density layer 1115L. In this case, the low optical density layer 1115L is arranged closer to the light transmitting portion 1111 than the high optical density layer 1115H is.

Now it will be described with reference to FIG. 3 why the optical attenuation layer 1115A can have its reflectance reduced by including a low optical density layer 1115L and a high optical density layer 1115H with a higher optical density than the low optical density layer 1115L. In the following description, the reflectance will refer herein to the energy reflectance unless otherwise stated. The entire disclosure of PCT International Application Publication No. 2010/070929 and its corresponding United States Laid-Open Patent Publication No. 2011/0249339 are hereby incorporated by reference.

Suppose in a situation where light is coming through the light transmitting portion 1111 (i.e., from over the light transmitting portion 1111 on the paper on which FIG. 3 is drawn), the reflectance at the interface S1 between the light transmitting portion 1111 and the low optical density layer 1115L is R₁, the reflectance at the interface S2 between the low optical density layer 1115L and the high optical density layer 1115H is R₂, and the reflectance at the interface S3 between the high optical density layer 1115H and the reflective layer 1113 is R₃. Also, suppose the intensity of the light incident on the light transmitting portion 1111 is I₁, the intensity of the light reflected from the interface S1 is Iᵣ₁, the intensity of the light transmitted through the interface S1 and incident on the low optical density layer 1115L is I₂, the intensity of the light reflected from the interface S2 is Iᵣ₂, the intensity of the light transmitted through the interface S2 and incident on the high optical density layer 1115H is I₃, and the intensity of the light reflected from the interface S3 is Iᵣ₃.

If the intensity Iᵣ₃ of the reflected light is considered to be so small as to be neglected, then the intensity Iᵣ of the light incident on the optical attenuation layer 1115A and then returning to the inside of the light transmitting portion 1111 (i.e., the intensity of the light reflected from the optical attenuation layer 1115A) can be represented by Iᵣ=Iᵣ₁+Iᵣ₂. Supposing the absorption coefficient of the low optical density layer 1115L is α₂ and the thickness of the low optical density layer 1115L is x₂, Iᵣ can be represented by the following Equation (2) (where indicates multiplication):

Iᵣ=R₁*I₁+R₂*I₂*(exp(−α₂*x₂))² (2)

Also, the reflectance R₁₂ (%) of the optical attenuation layer 1115A can be represented by the following Equation (3):

R₁₂(%)=(Iᵣ/I₁)*100 (3)

Thus, it can be seen from Equation (2) that to reduce the reflectance R₁₂ of the optical attenuation layer 1115A (i.e., to reduce the intensity Iᵣ of the light reflected from the optical attenuation layer 1115A), the reflectances R₁ and R₂ may be decreased.

In the unit reflective element 113, suppose the complex refractive index N_{T} of the light transmitting portion 1111 is N_{T}=n_{T}+i*k_{T}, the complex refractive index N_{L} of the low optical density layer 1115L is N_{L}=n_{L}+i*k_{L}, and the complex refractive index N_{H} of the high optical density layer 1115H is N_{H}=n_{H}+i*k_{H}. If the light is supposed to be incident perpendicularly to avoid complicating the formula, the reflectances R₁ and R₂ at the interfaces S1 and S2 can be represented by the following Equations (4) and (5), respectively:

R₁(%)=(((n_{T}−n_{L})²+(0−k_{L})²)/((n_{T}+n_{L})²+(0+k_{L})²))*100 (4)

R₂(%)=(((n_{L}−n_{H})²+(k_{L}−k_{H})²)/((n_{L}+n_{H})²+(k_{L}+k_{H})²))*100 (5)

On the other hand, the intensity of the transmitted light incident on a medium with an extinction coefficient k and a thickness L (at a wavelength is represented by the following Equation (6):

I=I₀*exp((−4πk*L)/Δ) (6)

If logₑ 10≈2.3, the following Equation (7) is obtained based on Equations (1) and (6):

OD=(4πk/Δ)*(L/2.3) (7)

As can be seen, the optical density is a quantity that depends on the extinction coefficient. Since the optical density depends on the extinction coefficient and since Equations (4) and (5) need to be satisfied, the reflectance R₁₂ of the optical attenuation layer 1115A can be reduced by adjusting the optical densities of the low optical density layer 1115L and high optical density layer 1115H. It should be noted that the low optical density layer 1115L and high optical density layer 1115H are supposed to be made of materials with mutually different extinction coefficients.

Actually light is incident obliquely onto the optical attenuation layer 1115A. Even so, the reflectance can also be calculated in the same way as in a situation where the light is incident perpendicularly. If light is incident obliquely onto the optical attenuation layer 1115A, the reflectance can be represented by a so-called “Fresnel coefficient”. For example, the amplitude reflectance rₚ₂ at the interface S2 with respect to P-polarized light and amplitude reflectance rₛ₂ at the interface S2 with respect to S-polarized light can be respectively represented by the following Equations (8) and (9) where θi indicates the angle of incidence and θt indicates the angle of refraction. The squares of the respective absolute values of these reflectances give the reflectances with respect to P- and S-polarized light.

rₚ₂=((N_{H}*cos θᵢ)−(N_{L}*cos θₜ))/((N_{H}*cos θᵢ)+(N_{L}*cos θₜ)) (8)

rₛ₂=((N_{L}*cos θᵢ)−(N_{H}*cos θₜ))/((N_{L}*cos θᵢ)+(N_{H}*cos θₜ)) (9)

As can be seen, by forming the optical attenuation layer 1115A as a multilayer structure including the low optical density layer 1115L and the high optical density layer 1115H, the reflectance of the optical attenuation layer 1115A can be reduced.

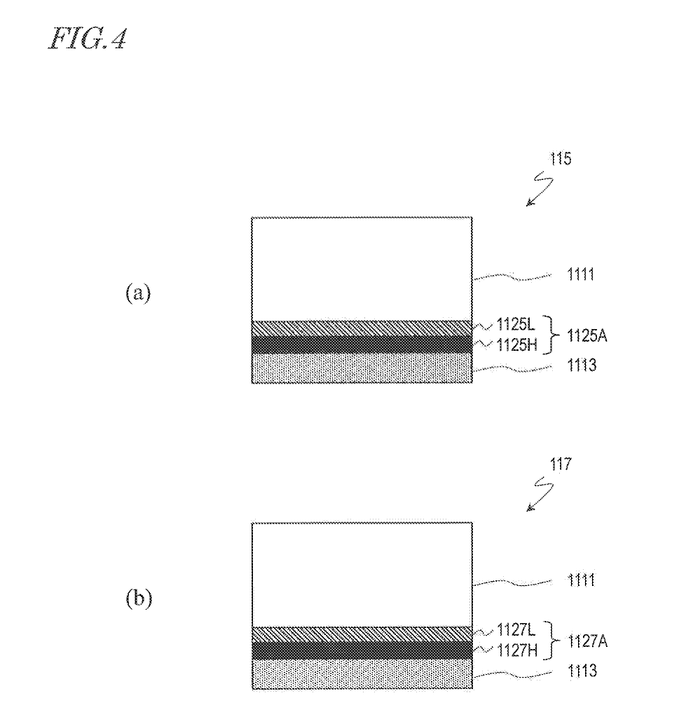

FIG. 4(a) is a schematic cross-sectional view illustrating an exemplary configuration for a unit reflective element 115 including an optical attenuation layer 1125A consisting of a low optical density layer 1125L and a high optical density layer 1125H.

In the exemplary configuration shown in FIG. 4(a), the high optical density layer 1125H is a layer including a black coloring agent. The material for the high optical density layer 1125H may be a resin composition including a black coloring agent and a resin. Alternatively, the high optical density layer 1125H may also be a black adhesive layer.

The low optical density layer 1125L may be either a transparent resin layer or a resin layer including a coloring agent. If the low optical density layer 1125L includes a coloring agent, then the low optical density layer 1125L may be made of a resin composition including an inorganic or organic pigment and a resin. The pigment may be an appropriate one selected from the group consisting of red pigments, yellow pigments, green pigments, blue pigments, purple pigments and various other pigments.

As can be seen from Equation (4), the closer to the refractive index of the light transmitting portion 1111 the refractive index of the low optical density layer 1125L is, the lower the reflectance R₁ gets. In this case, among the red, yellow, green, blue and purple pigments, the refractive index of the blue pigment is close to 1.5. That is why if glass (with a refractive index of approximately 1.5) is used as a material to make the light transmitting portion 1111, the blue pigment is suitably used to form the low optical density layer 1125L.

FIG. 4(b) is a schematic cross-sectional view illustrating an exemplary configuration for a unit reflective element 117 including an optical attenuation layer 1127A consisting of a low optical density layer 1127L and a high optical density layer 1127H. In the example illustrated in FIG. 4(b), the low optical density layer 1127L is implemented as a dielectric layer and the high optical density layer 1127H is implemented as a metal layer. In this manner, the low optical density layer 1127L may include at least one dielectric layer and the high optical density layer 1127H may include a metal layer. In the following description, the dielectric layer functioning as the low optical density layer will be identified by the same reference numeral as the low optical density layer's and the metal layer functioning as the high optical density layer will be identified by the same reference numeral as the high optical density layer's

In the unit reflective element 117 shown in FIG. 4(b), the dielectric layer 1127L is stacked as an antireflective film on the metal layer 1127H functioning as a light absorber. If an antireflective film is provided on a transparent substrate, it means that the transmittance will rise. However, if an antireflective film is provided on a light absorber such as a metallic material, then it means that light will be absorbed into the light absorber at an increased absorptance.

Next, the optical properties of the metal layer 1127H as a light absorber will be described. In the following description, the refractive index of the light transmitting portion 1111 will be represented by n₀, the refractive index of the dielectric layer 1127L by n₁, and the complex refractive index Nₛ of the metal layer 1127H by nₛ−i*kₛ, respectively. The entire disclosures of Japanese Patent No. 3979982 and its corresponding U.S. Pat. No. 7,113,339 are hereby incorporated by reference.

FIG. 5 is a graph showing the respective refractive indices nₛ and extinction coefficients kₛ of various kinds of absorbers (including various metals and semiconductors) with respect to light falling within the visible radiation range. The wavelength range plotted varies from one element to another but FIG. 5 provides data about a wavelength range of roughly 400 nm to 800 nm. In FIG. 5, the semi-circular curves represent the refractive indices nₛ and extinction coefficients kₛ of the metal layer 1127H that reflects perfectly no light at all when the refractive index n₁ of the dielectric layer 1127L has respective values falling within the range of 2 to 3.5. In this case, the glass' refractive index of 1.52 is used as the refractive index n₀ of the light transmitting portion 1111.

First of all, look at those semi-circular curves shown in FIG. 5. The nₛ value at which each semi-circular curve rises is equal to the value of the refractive index n₀ of the light transmitting portion 1111. That is to say, unless the refractive index nₛ of the metal layer 1127H satisfies the condition nₛ>n₀, antireflection cannot be achieved effectively.

Also, to achieve antireflection effectively, the refractive index n₁ of the dielectric layer 1127L also needs to satisfy the condition n₁>n₀. As shown in FIG. 5, the greater the refractive index n₁ of the dielectric layer 1127L, the larger the diameter of the circle. That is why the greater the refractive index n₁ of the dielectric layer 1127L, the more easily the condition to achieve the antireflection effect can be satisfied. That is to say, it can be seen that the greater the refractive index n₁ of the dielectric layer 1127L, the broader the range from which the material for the metal layer 1127H can be chosen and/or the more easily the metal layer 1127H gets affected by wavelength dispersion. Although FIG. 5 shows a situation where the light transmitting portion 1111 is glass (with n₀ of 1.52), the smaller the refractive index n₀ of the light transmitting portion 1111, the larger the diameter of the semi-circle. For that reason, by using a transparent resin which has a lower refractive index than glass as the material to make the light transmitting portion 1111, the effects described above can be achieved in a broader range.

Examples of specific materials for the metal layer 1127H include molybdenum (Mo), tantalum (Ta), chromium (Cr), tungsten (W) and alloys including at least one of these metallic elements. Specifically, an indium oxide such as In₂O₃ or ITO (indium tin oxide) may be used as a material for the dielectric layer 1127L.

The respective materials and thicknesses of the metal layer 1127H and dielectric layer 1127L can be selected appropriately according to the relative position of the reflective imaging element 1 with respect to the object, the angle of incidence of light on the optical attenuation layer 1127A and the refractive index of the material for the light transmitting portion 1111. If a display panel is applied to the object, the respective materials and thicknesses of the metal layer 1127H and dielectric layer 1127L can be selected appropriately with the viewing angle characteristic of the display panel also taken into account.

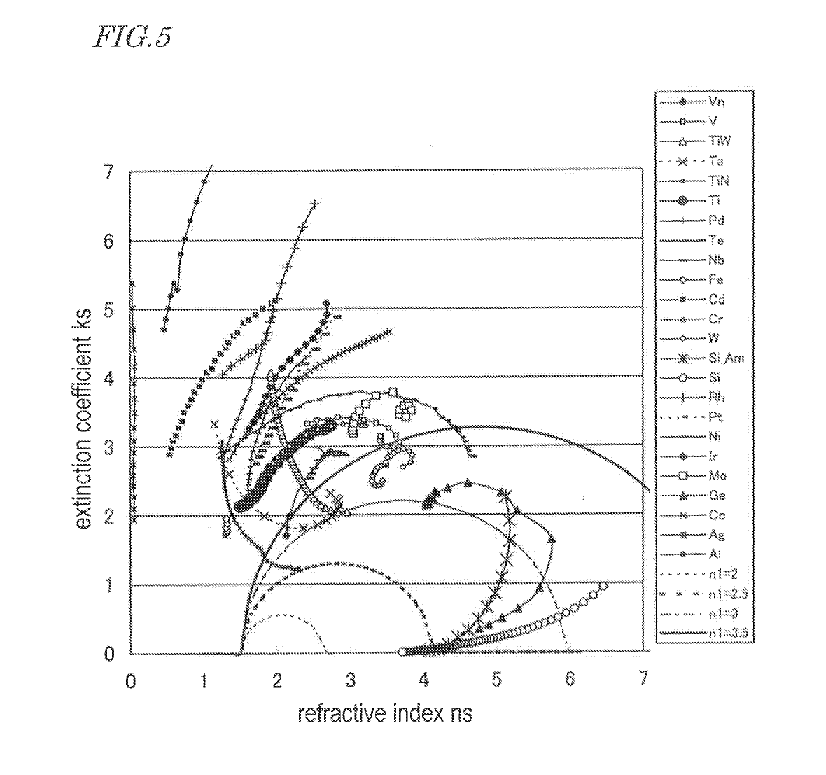

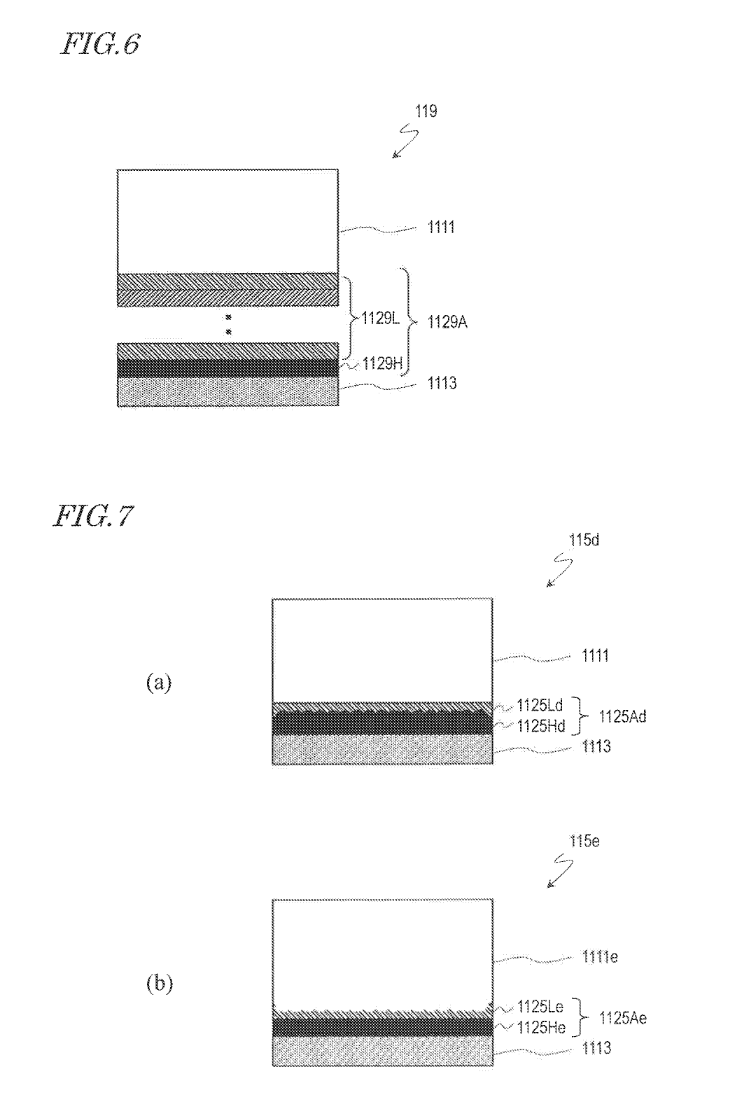

FIG. 6 is a schematic cross-sectional view illustrating an exemplary configuration for a unit reflective element 119 including an optical attenuation layer 1129A consisting of a low optical density layer 1129L and a high optical density layer 1129H. In the example illustrated in FIG. 6, the low optical density layer 1129L includes two or more dielectric layers. The low optical density layer 1129L shown in FIG. 6 is a multilayer film in which a plurality of dielectric layers with mutually different refractive indices are stacked one upon the other.

Generally speaking, an optical thin film with a certain refractive index may be replaced equivalently with a multilayer film that is a stack of a layer, of which the refractive index is greater than the certain refractive index (and which will be hereinafter referred to as a “high refractive index layer”), and a layer, of which the refractive index is less than the certain refractive index (and which will be hereinafter referred to as a “low refractive index layer”). Such a multilayer film is called an “equivalent multilayer film” and is characterized by a single complex refractive index. Examples of materials for respective layers that form such a multilayer film include fluorides such as MgF₂ and CaF₂ and oxides such as SiO₂ and TiO₂. If the low optical density layer 1129L is implemented as an equivalent multilayer film and if the high optical density layer 1129H is implemented as metal layer, the antireflection effect can be achieved in an even broader wavelength range.

It should be noted that if the optical attenuation layer has a multilayer structure consisting of a low optical density layer and a high optical density layer, the interface between the low optical density layer and the high optical density layer may be a surface with micro-geometry.

FIG. 7(a) illustrates an example of a unit reflective element 1115d, of which the optical attenuation layer 1125Ad is a stack of a low optical density layer 1125Ld and a high optical density layer 1125Hd and in which the interface between the low optical density layer 1125Ld and the high optical density layer 1125Hd is a surface with micro-geometry. As shown in FIG. 7(a), the high optical density layer 1125Hd may have a diffuse reflective surface which faces the light transmitting portion 1111. In this case, the low optical density layer 1125Ld and high optical density layer 1125Hd are made of materials with mutually different refractive indices.

By adopting such a structure, the light reflected from the interface between the low optical density layer 1125Ld and high optical density layer 1125Hd can be dispersed and the object can be prevented from being imaged at an unintentional position other than the position that is symmetric with respect to the reflective imaging element 1 as a plane of symmetry.

Alternatively, the interface between the light transmitting portion and the low optical density layer may have such a surface with micro-geometry.

FIG. 7(b) illustrates an example of a unit reflective element 1115e, of which the optical attenuation layer 1125Ae is a stack of a low optical density layer 1125Le and a high optical density layer 1125He and in which the interface between the light transmitting portion 1111e and the low optical density layer 1125Le is a surface with micro-geometry. As shown in FIG. 7(b), the light transmitting portion 1111e may have a diffuse reflective surface which faces the high optical density layer 1125He. In this case, the light transmitting portion 1111e and the low optical density layer 1125Le are also made of materials with mutually different refractive indices.

By adopting such a structure, the light emitted through the light transmitting portion 1111e toward the high optical density layer 1125He can be dispersed and the high optical density layer 1125He can function effectively as a light absorber. As a result, emission of stray light rays from the reflective imaging element 1 can be reduced significantly. The same effects can also be achieved even by attaching a light diffusive sheet onto the light transmitting portion 1111.

(Optical System)

Next, an optical system as an embodiment of the present invention will be described.

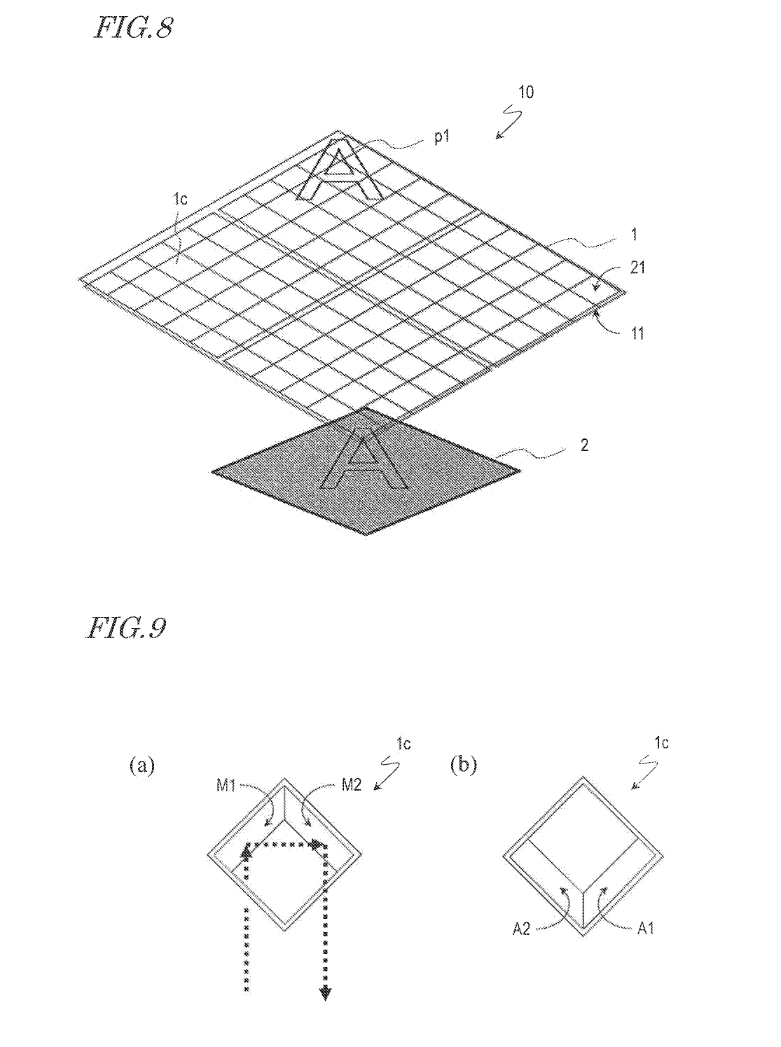

FIG. 8 is a schematic perspective view illustrating a configuration for an optical system 10 according to an embodiment of the present invention. As shown in FIG. 8, the optical system 10 includes a reflective imaging element 1 and a display panel 2 which is arranged on a light-incident side of the reflective imaging element 1. The reflective imaging element 1 may have the configuration shown in FIGS. 1(a) to 1(c), for example. This optical system 10 forms an image being displayed on the display screen of the display panel 2 at a position (i.e., produces an aerial image p1) that is symmetric with respect to the reflective imaging element 1 as a plane of symmetry.

In this optical system 10, the display panel 2 is arranged so that its display screen is tilted with respect to the plane defined by the reflective imaging element 1. By getting the display screen of the display panel 2 tilted with respect to the plane defined by the reflective imaging element 1, this optical system 10 can display an image which looks floating to the viewer's eye. In this case, the plane defined by the reflective imaging element 1 is parallel to a plane including the first and second directions D1 and D2 shown in FIG. 1(b). In the example illustrated in FIG. 8, the display panel 2 is supposed to be arranged closer to the first reflective element 11 of the reflective imaging element 1. However, the second reflective element 21 of the reflective imaging element 1 may be located on a light-incident side. The display panel 2 may be, but does not have to be, a liquid crystal display panel. Alternatively, the display panel 2 may also be an organic EL (electro-luminescence) display panel or a plasma display panel, for example.

Next, it will be described with reference to the accompanying drawings how the reflective imaging element 1 functions in this optical system 10.

As shown in FIG. 8, the reflective imaging element 1 includes a plurality of unit image forming elements 1c which are arranged in matrix. As shown in FIGS. 9(a) and 9(b), each unit image forming element 1c includes one of a plurality of reflective layers 1113 included in the first reflective element 11 (and which will be hereinafter referred to as a “first specular element M1”) and one of a plurality of reflective layers 1113 included in the second reflective element 21 (and which will be hereinafter referred to as a “second specular element M2”). Each unit image forming element 1c further includes one of a plurality of optical attenuation layers 1115 included in the first reflective element 11 (and which will be hereinafter referred to as a “first optical attenuation element A1”) and one of a plurality of optical attenuation layers 1115 included in the second reflective element 21 (and which will be hereinafter referred to as a “second optical attenuation element A2”). Thus, it can be said that in the reflective imaging element 1, each of the plurality of unit image forming elements 1c is a region surrounded with the first and second specular elements M1 and M2 and the first and second optical attenuation elements A1 and A2.

As shown in FIG. 9(a), the light emitted from the display panel 2 is reflected once apiece from the first and second specular elements M1 and M2 and then goes out of this reflective imaging element 1 toward the viewer. The light that has been reflected once apiece from each of the first and second specular elements M1 and M2 inside each unit image forming element 1c contributes to producing an object image at a position which is symmetric with respect to the reflective imaging element 1 as a plane of symmetry. As can be seen easily from FIGS. 9(a) and 9(b), in this optical system 10, the orientation of the reflective imaging element 1 with respect to the display panel 2 is set so that the light emitted from the display panel 2 and sequentially reflected from the first and second specular elements M1 and M2 is directed toward the viewer.

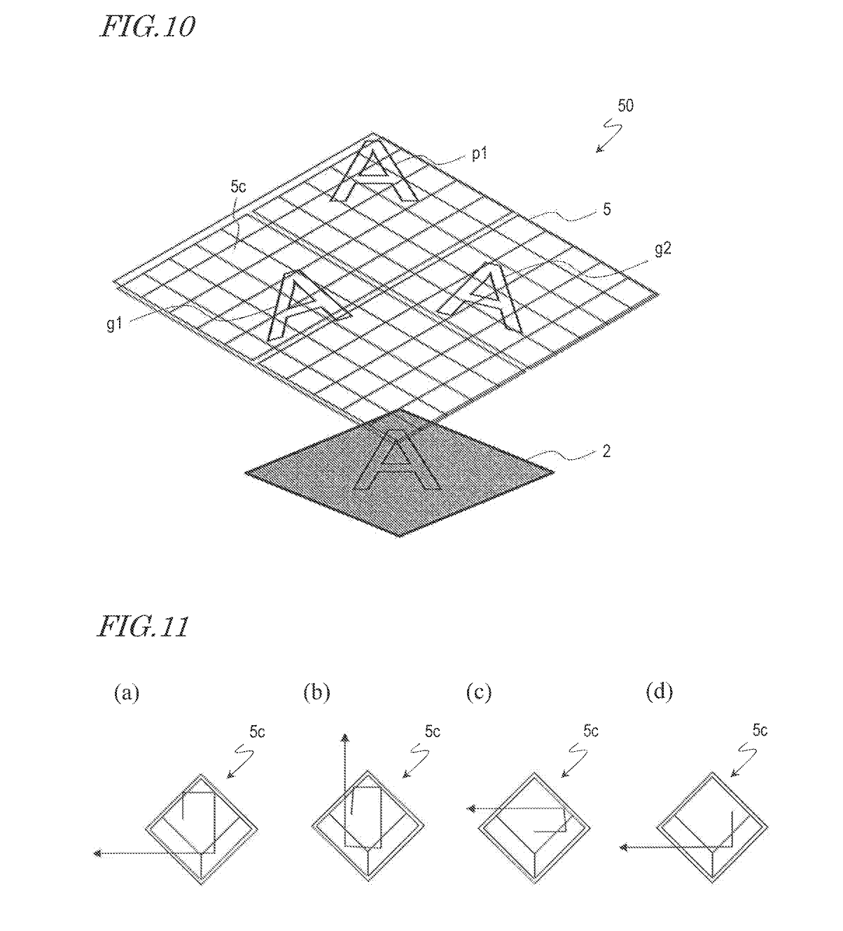

FIG. 10 illustrates, as a comparative example, an optical system 50 including a reflective imaging element 5 with no optical attenuation layers. As shown in FIG. 10, the reflective imaging element 5 includes a plurality of unit image forming elements 5c which are arranged in matrix.

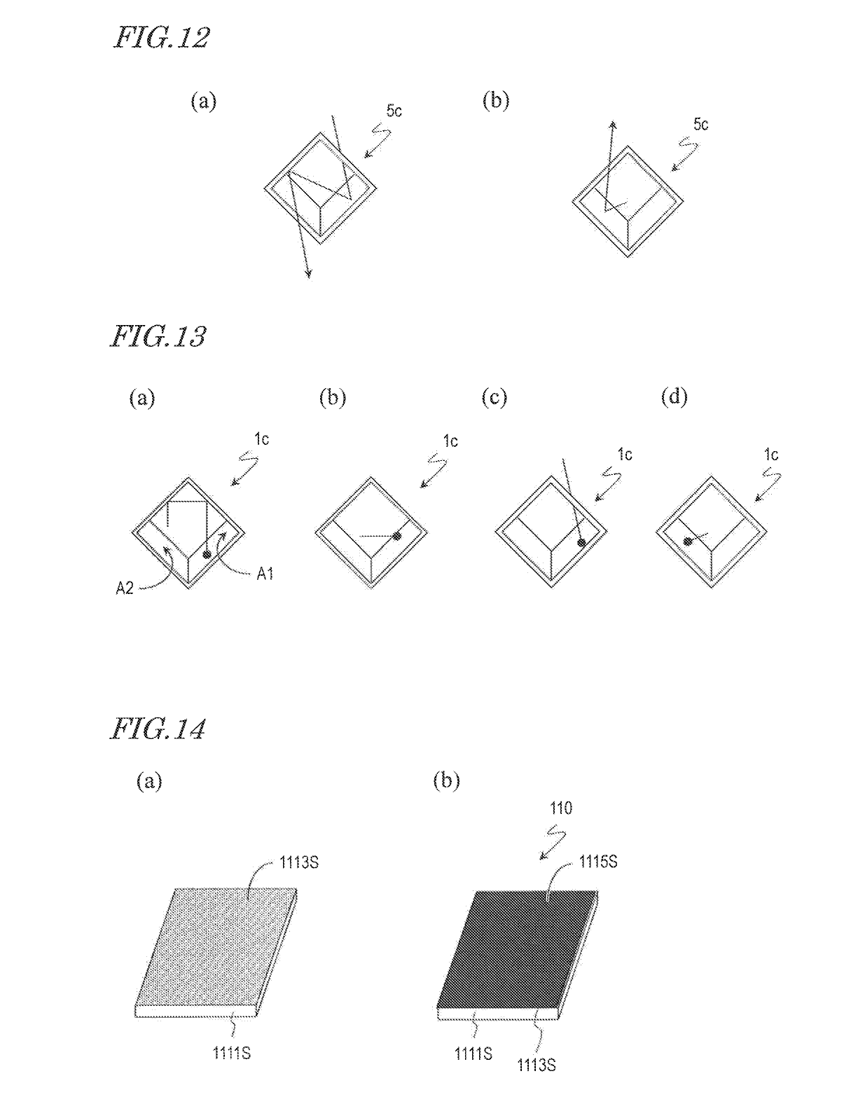

FIGS. 11(a) through 11(d) and FIGS. 12(a) and 12(b) illustrate, as a comparative example, a unit image forming element 5c in the reflective imaging element 5 including no optical attenuation layers. FIGS. 11(a) through 11(d) and FIGS. 12(a) and 12(b) schematically illustrate examples of stray light rays. In the reflective imaging element 5 including no optical attenuation layers, the light emitted from the display panel 2 is reflected from a surface, not from the specular elements as shown in FIGS. 11(a) to 11(d). If such light that has been reflected from a surface other than the specular elements is directed toward the viewer, the visibility of an aerial image that should be produced will decrease. For example, such stray light rays may produce an object image somewhere between the reflective imaging element 5 and the viewer (such as the images g1 and g2 schematically shown in FIG. 10).

Also, if there is a light source at a different position from the display panel 2, the light incident on the reflective imaging element 5 includes light emitted from that different light source from the display panel 2. In the reflective imaging element 5 including no optical attenuation layers, the light emitted from such a different light source from the display panel 2 may be reflected from a surface, not from the specular elements as shown in FIGS. 12(a) and 12(b). If such light that has been emitted from a light source at a different position from the display panel 2 and reflected from a surface other than the specular elements is directed from the reflective imaging element 5 toward the viewer, the contrast ratio of an aerial image that should be produced (such as the aerial image p1) will decrease.

FIGS. 13(a) through 13(d) are schematic representations illustrating a single unit image forming element 1c extracted from the reflective imaging element 1 according to an embodiment of the present invention. As shown in FIGS. 13(a) through 13(d), in each unit image forming element 1c of the reflective imaging element 1 according to an embodiment of the present invention, the light incident on the first optical attenuation element A1 is hardly reflected from the first optical attenuation element A1. Likewise, the light incident on the second optical attenuation element A2 is hardly reflected from the second optical attenuation element A2, either. Consequently, such emission of stray light rays as shown in FIGS. 11(a) through 11(d) and FIGS. 12(a) and 12(b) can be reduced significantly.

That is to say, according to an embodiment of the present invention, emission of light that does not contribute to producing an object image at such a position that is symmetric with respect to the reflective imaging element 1 as a plane of symmetry can be reduced significantly. In other words, an object image that could be produced at positions other than such a position that is symmetric with respect to the reflective imaging element as a plane of symmetry is hardly visible anymore, and therefore, an image that looks floating to the viewer's eye can be presented with high display quality.

In addition, the light incident on the first optical attenuation element A1 is hardly reflected from the first optical attenuation element A1. Likewise, the light incident on the second optical attenuation element A2 is hardly reflected from the second optical attenuation element A2, either. That is why both the light incident on the first optical attenuation element A1 and the light incident on the second optical attenuation element A2 are hardly reflected outward from the reflective imaging element 1. This means that the entire reflective imaging element 1 to be the background for the aerial image looks black.

Consequently, according to an embodiment of the present invention, the reflective imaging element will look solid black, and therefore, the contrast ratio can be increased in a bright area of the aerial image.

(Method for Fabricating Reflective Imaging Element)

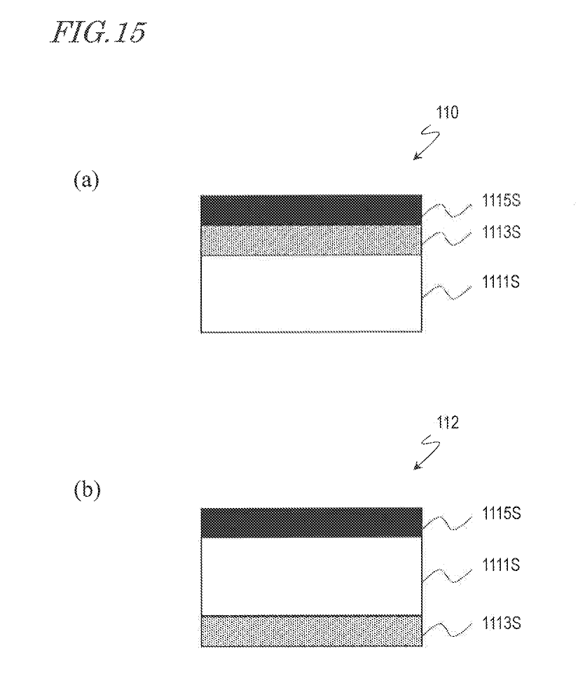

Next, it will be described with reference to FIGS. 14 through 17 how to fabricate the reflective imaging element 1 of this embodiment.

First of all, a transparent light transmitting substrate 1111S is provided. As the light transmitting substrate 1111S, either a glass substrate or a transparent resin substrate may be used, for example. Alternatively, a transparent resin film may also be used as the light transmitting substrate 1111S. In that case, as can be seen easily from the following description, the pitch of the plurality of reflective layers 1113 can be reduced in each of the first and second reflective elements 11 and 21 and the resolution of the aerial image can be increased.

Next, as shown in FIG. 14(a), a reflective layer 1113S is formed on the light transmitting substrate 1111S. For example, a metal thin film such as an aluminum thin film is formed one principal surface of the light transmitting substrate 1111S. As a technique for forming the reflective layer 1113S on one principal surface of the light transmitting substrate 1111S, a sputtering process or an evaporation process may be used.

Subsequently, as shown in FIG. 14(b), a material to make an optical attenuation layer 1115S is put on the reflective layer 1113S that has been formed on the light transmitting substrate 1111S. For example, if the optical attenuation layer 1115S is going to be a black adhesive layer, a resin composition including a black coloring agent and a resin is applied onto the reflective layer 1113S. As the resin, a curable resin may be used. Examples of curable resins include photosensitive resins, thermosetting resins and thermoplastic resins. As the photosensitive resin, a UV curable acrylic resin may be used, for example.

The resin composition may be applied onto the reflective layer 1113S by either coating or printing. The reflective layer 1113S may get coated with a resin composition with a spin coater, a gravure coater, a roll coater, a knife coater, or a die coater. Instead of applying the resin composition onto the reflective layer 1113S, a transfer sheet on which the resin composition has already been put on a separator in advance may also be used. The thickness of the resin composition may be set to be about a few μm, for example, but may be adjusted appropriately according to the material of the resin composition.

Also, if the optical attenuation layer 1115S is going to be a stack of a metal layer and a dielectric layer, then a metal layer may be formed on the reflective layer 1113S first, and then a dielectric layer may be formed on the metal layer. To form the metal layer and the dielectric layer, either a sputtering process or an evaporation process may be used.

On the other hand, if the optical attenuation layer 1115S is going to be a stack including a low optical density layer and a high optical density layer, then the high optical density layer may be subjected to sandblasting. Then, the interface between the low optical density layer and the high optical density layer can be a surface with a micro-geometry. If the high optical density layer is to be made of a resin composition, the same effect can be achieved by adding glass beads or powder of aluminum oxide to the resin composition, for example. Optionally, a light diffusive sheet may be arranged between the low optical density layer and the high optical density layer.

To make the interface between the light transmitting portion and the low optical density layer a micro-geometric surface, one of the principal surfaces of the light transmitting substrate 1111S on which no reflective layer is going to be formed may be subjected to sandblasting. If a glass substrate is adopted as the light transmitting substrate 1111S, then etching processing may be used.

In this manner, a stacked substrate 110 consisting of the light transmitting 1111S, the reflective layer 1113S and the optical attenuation layer 1115S is obtained. A schematic cross-sectional view of the stacked substrate 110 in such a situation is shown in FIG. 15(a).

Although the resin composition is supposed to be applied onto the reflective layer 1113S in the example described above, the resin composition may also be applied onto the other principal surface of the light transmitting substrate 111S that faces the reflective layer 1113S (i.e., on the principal surface on the opposite side from the reflective layer 1113S). Or a metal layer may also be formed on the other principal surface of the light transmitting substrate 1111S that faces the reflective layer 1113S. A schematic cross section of the stacked substrate 112 in such a situation is shown in FIG. 15(b).

Optionally, the reflective layer 1113S and optical attenuation layer 1115S may also be formed using a transfer sheet in which a metal thin film, an adhesive layer including a black coloring agent and a separator have been stacked one upon the other in advance. If a transparent resin is used as material for the light transmitting substrate 111S, a sheet of a composite material in which a transparent resin sheet, the reflective layer 1113S and the optical attenuation layer 1115S have been combined together in advance may also be used as the stacked substrate 110.

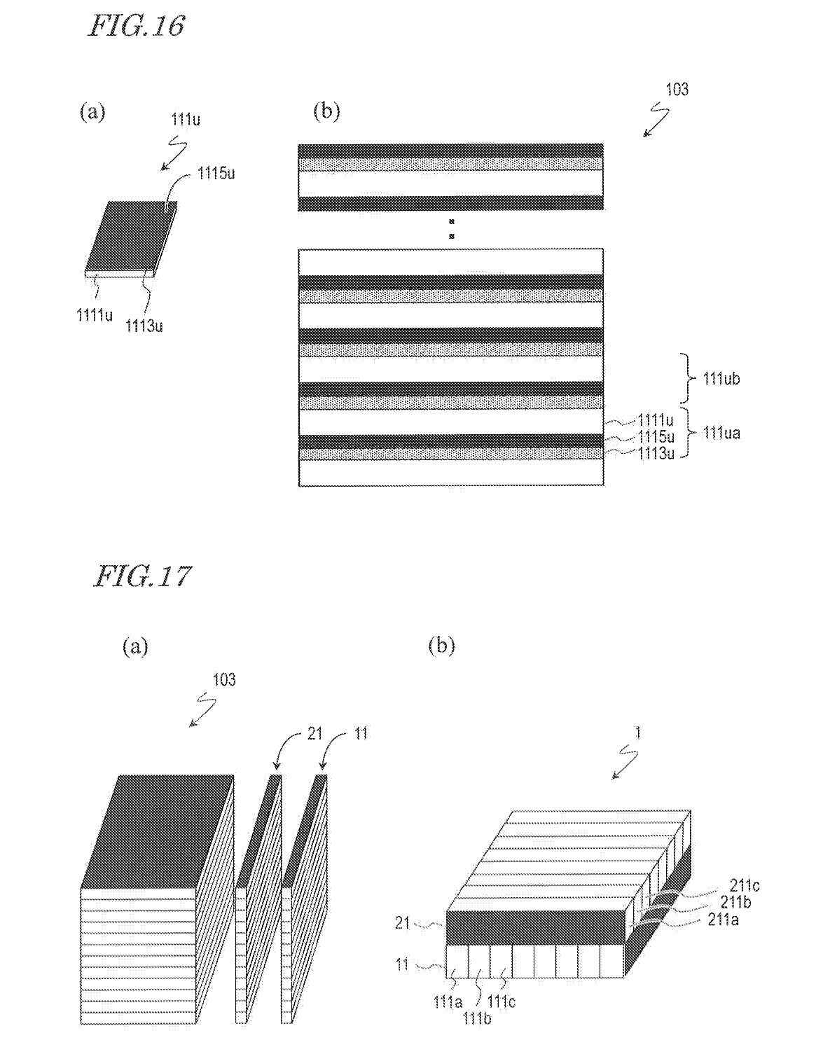

Next, by cutting the stacked substrate 110 thus obtained to an intended size with a diamond wheel or any other suitable tool, a stack unit 111u consisting of the light transmitting substrate 1111u, the reflective layer 1113u and the optical attenuation layer 1115u is formed as shown in FIG. 16(a). It should be noted that if a stack unit 111u consisting of the light transmitting substrate 1111u, the reflective layer 1113u and the optical attenuation layer 1115u is going to be formed using the light transmitting substrate 1111S that has been machined to an intended size in advance, the process step of cutting the stacked substrate 110 to an intended size can be omitted.

Next, a plurality of stack units 111u are stacked on upon the other. As a result, a stack 103 in which a plurality of unit structures 111ua, 111ub, and so on are stacked one upon the other is obtained as shown in FIG. 16(b). Each of the plurality of unit structures 111ua, 111ub, and so on includes the light transmitting substrate 1111u, the reflective layer 1113u, and the optical attenuation layer 1115u arranged between the light transmitting substrate 1111u and the reflective layer 1113u. The plurality of unit structures include two mutually adjacent unit structures which are arranged so that the light transmitting substrate 1111u of one unit structure is adjacent to the reflective layer 1113u of the other unit structure. FIG. 16(b) illustrates an example in which two mutually adjacent unit structures 111ua and 111ub are arranged so that the light transmitting substrate 1111u of one unit structure 111ua is adjacent to the reflective layer 1113u of the other unit structure 111ub.

Next, as shown in FIG. 17(a), the stack 103 is cut in the direction in which a plurality of unit structures 111ua, 111ub and so on are stacked one upon the other in the stack 103. The stack 103 may be cut with a wire saw or any other suitable cutter. By using a wire saw to cut the stack 103, the warp of the fragments can be reduced. In addition, the tilt of the cut face with respect to the direction in which the plurality of unit structures 111ua, 111ub and so on are stacked one upon the other can be reduced as well. If necessary, the cut face of the fragments thus obtained may be polished.

By cutting the stack 103 a number of times, a plurality of fragments can be obtained. One of those fragments may be used as the first reflective element 11 and another one of them may be used as the second reflective element 21. Each of the first and second reflective elements 11 and 21 has a multilayer structure in which a plurality of unit reflective elements are stacked one upon the other.

Next, as shown in FIG. 17(b), the second reflective element 21 is arranged on the first reflective element 11. In this case, the direction in which a plurality of unit reflective elements 111a, 111b, 111c and so on are stacked one upon the other in the first reflective element 11 and the direction in which a plurality of unit reflective elements 211a, 211b, 211c and so on are stacked one upon the other in the second reflective element 21 need to intersect with each other at right angles.

By performing these process steps, a reflective imaging element 1 can be obtained without performing a complicated manufacturing process.

Some specific examples of a method for fabricating a reflective imaging element 1 according to this embodiment will now be described.

### Example 1

First of all, a non-alkali glass substrate with a thickness of 0.3 mm is provided. Next, an aluminum film is deposited on one of the two principal surfaces of the non-alkali glass substrate by sputtering process. Then, a resin composition including carbon black and a curing resin is applied onto the aluminum film with a spin coater. Optionally, after the resin composition applied onto the aluminum film has cured, a resin layer obtained by curing the resin composition may be subjected to sandblasting.

Next, the non-alkali glass substrate on which the aluminum film and the resin layer have been formed is cut with a diamond wheel. As a result, some fragments of the substrate, each having a size of 100 mm×100 mm, for example, can be obtained.

Subsequently, those fragments of the substrate that have been obtained in the last process step are stacked one upon the other with a thermosetting resin interposed between them. The stack thus formed may have a height of 100 mm, for example. Then, by curing the thermosetting resin, a stack in which a number of unit structures are stacked one upon the other can be obtained.

Thereafter, the stack is cut with a wire saw in the direction in which the plurality of unit structures are stacked one upon the other in the stack. In this case, the cutting pitch may be 0.9 mm, for example.

Next, two of those fragments with a thickness of 0.9 mm are bonded together. In this case, these two fragments are bonded together so that a plurality of aluminum films of one fragment cross a plurality of aluminum films of the other fragment at right angles. It should be noted that these two fragments may be bonded together with a UV curable resin. To prevent the display quality of the aerial image from getting debased, a UV curable resin, of which the refractive index is almost the same as that of the non-alkali glass substrate, is suitably selected as the UV curable resin.

### Example 2

A reflective imaging element as a second example may be fabricated in the same way as in the first example except that a metal film and a dielectric film are sequentially formed on an aluminum film instead of applying a resin composition onto the aluminum film. As a material to make the metal film, a molybdenum (Mo) alloy may be selected, for example. As a material to make the dielectric film, an indium (In) based oxide may be selected, for example. Each of the metal film and dielectric film may be formed by sputtering process. The thickness of the dielectric film may be adjusted so that the reflectance with respect to light with a wavelength of around 550 nm, at which the luminosity factor is the highest, becomes as low as possible.

### INDUSTRIAL APPLICABILITY

Embodiments of the present invention are broadly applicable to any optical system including a reflective imaging element which can form an object image in a space and a display panel.

### REFERENCE SIGNS LIST

1 reflective imaging element
2 display panel
10 optical system
11 first reflective element
21 second reflective element
1111 light transmitting
1113 reflective layer
1115 optical attenuation layer
1115H high optical density layer
1115L low optical density layer

1. A reflective imaging element comprising:
a first reflective element; and
a second reflective element arranged over the first reflective element,
wherein each of the first and second reflective elements has a multilayer structure in which a plurality of unit reflective elements are stacked one upon the other,
each of the plurality of unit reflective elements includes a light transmitting portion, a reflective layer, and an optical attenuation layer arranged between the light transmitting portion and the reflective layer,
the plurality of unit reflective elements include two unit reflective elements which are adjacent to each other and which are arranged so that the light transmitting portion of one of the two unit reflective elements is adjacent to the reflective layer of the other unit reflective element, and
the direction in which the plurality of unit reflective elements are stacked in the first reflective element and the direction in which the plurality of unit reflective elements are stacked in the second reflective element intersect with each other at right angles.

2. The reflective imaging element of claim 1, wherein the optical attenuation layer includes a low optical density layer and a high optical density layer which has a higher optical density than the low optical density layer, and
the low optical density layer is arranged closer to the light transmitting portion than the high optical density layer is.

3. The reflective imaging element of claim 2, wherein the high optical density layer includes a black coloring agent.

4. The reflective imaging element of claim 2, wherein the low optical density layer includes at least one dielectric layer, and
the high optical density layer includes a metal layer.

5. The reflective imaging element of claim 2, wherein the high optical density layer has a diffuse reflective surface which faces the light transmitting portion.

6. The reflective imaging element of claim 2, wherein the light transmitting portion has a diffuse reflective surface which faces the high optical density layer.

7. An optical system comprising:
the reflective imaging element of claim 1; and
a display panel which is arranged on a light-incident side of the reflective imaging element,
wherein the optical system forms an image which is displayed on a display screen of the display panel at a position which is symmetric with respect to the reflective imaging element as a plane of symmetry.

8. A method for fabricating the reflective imaging element of claim 1, the method comprising the steps of:
(a) providing a stack in which a plurality of unit structures are stacked one upon the other, each of the plurality of unit structures including a light transmitting substrate, a reflective layer, and an optical attenuation layer arranged between the light transmitting substrate and the reflective layer;
(b) cutting the stack in a direction in which the plurality of unit structures are stacked one upon the other in the stack, thereby forming first and second reflective elements, each having a multilayer structure in which a plurality of unit reflective elements are stacked one upon the other; and
(c) arranging the second reflective element over the first reflective element so that a direction in which the plurality of unit reflective elements are stacked in the first reflective element intersects at right angles with a direction in which the plurality of unit reflective elements are stacked in the second reflective element.

9. The method of claim 8, wherein the step (a) includes the step of applying a resin composition including a black coloring agent onto the reflective layer.

10. The method of claim 8, wherein the step (a) includes the step of forming a metal layer on the reflective layer.

11. The method of claim 8, wherein the step (a) includes the step of applying a resin composition including a black coloring agent onto one of the light transmitting substrate's principal surfaces that faces the reflective layer.

12. The method of claim 8, wherein the step (a) includes the step of forming a metal layer on one of the light transmitting substrate's principal surfaces that faces the reflective layer.
